(19) United States
(12) Patent Application Publication
(10) Pub. No.: US 2014/0353232 A1
(43) Pub. Date: Dec. 4, 2014

(54) Water Clarification System and Method

(71) Applicant: Thomas Minihan, Bunnell, FL (US)

(72) Inventor: Thomas Minihan, Bunnell, FL (US)

(21) Appl. No.: 14/291,072

(22) Filed: May 30, 2014

Related U.S. Application Data
(60) Provisional application No. 61/828,896, filed on May 30, 2013.

(51) Int. Cl. C02F 1/00; B01D 21/24; B01D 21/00

(52) U.S. Cl. CPC C02F 1/006; C02F 1/00; B01D 21/0042; B01D 21/0003; B01D 21/2405; B01D 2021/0078
USPC 210/232; 210/513; 210/521; 210/519; 210/532.1

(57) ABSTRACT

A modular, portable, gravity fed clarification system includes internal surfaces which come in contact with the water to be clarified which are clad in a non-reactive plastic.

This application claims the benefit of U.S. Provisional Patent Application Ser. No. 61/828,896 filed May 30, 2013.

### FIELD OF THE INVENTION

The present invention relates generally to the field of water clarification systems and methods. More particularly, this invention relates to a modular, portable, gravity fed clarification system in which all internal surfaces which come in contact with the water to be clarified are clad in a non-reactive plastic.

### BACKGROUND OF THE INVENTION

Construction of buildings such as office buildings often results in large quantities of waste water. This type of waste water often contains undesirable constituents which must be disposed of in a landfill or other waste storage area.

During the treatment of this type of wastewater, a residuals stream may may be separated into a liquid-rich stream and a solid-rich stream. The liquid-rich stream may also be referred to as a “centrate” or a “filtrate,” depending on the separation technique used, in reference to centrifuges and filters, respectively. In some cases, a treatment agent may be added, for example, to promote aggregation of solid material for easier handling, separation, or disposal. The optimal amount of treatment agent may be a function of the solids content, which can vary from worksite to worksite.

### SUMMARY OF THE INVENTION

The present invention provides a mobile, temporary water clarification system arranged for deployment at a work site. The system comprises a multi-layer, gravity fed system that receives a stream of waste water for treatment into the top of the system for flow through a plurality of layers into a settlement tank. In between the inlet of the waste water and the settlement tank, a plurality of flocculent trays cause the settlement of solids from the waste water. The flow rate may be flexibly varied by the adjustment of flow plates through which the water flows. Finally, the entire interior surface of the system is covered in a non-reactive material, preferably a plastic, to reduce the amount of extraneous materials added to the water under treatment.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a side elevation view of the system of this invention.

FIG. 2 is a top view of the system of FIG. 1.

FIG. 3 is a side section view of the system of FIG. 1.

FIG. 4 is a section view of the system of FIG. 1 taken along the section lines 4-4 as shown in FIG. 1.

FIG. 5 is a section view of the system including outrigger support arms.

FIG. 6 is a side section view of two system sections coupled together to double the flow length of channels carrying water through the system.

FIG. 7 is a top view of a plurality of system sections coupled together to further increase the flow length of flow channels and further including a 90° coupling section to accommodate the footprint available at a worksite.

FIG. 8 is a top view of a plurality of system sections coupled together to further increase the flow length of flow channels and further including a 180° coupling section to accommodate another, different footprint available at a worksite.

FIG. 9 is a section view of the system of FIG. 8 taken along section lines 9-9 as shown in FIG. 8.

FIG. 10 is a section view of the system of FIG. 8 taken along section lines 10-10 as shown in FIG. 8.

FIG. 11 is a side elevation view of a system section illustrating access openings and lifting points to accommodate a fork lift for moving the section off of and onto a transport vehicle as well as moving the section around a worksite.

FIG. 12 is an end elevation view of the system section of FIG. 11.

FIG. 13 is a section detail of the section views of FIGS. 11 and 12 illustrating a presently preferred embodiment of access openings into the system.

FIG. 14 is a section detail of the sections view of FIGS. 11 and 12 illustrating dogs operated to permit removal of doors closing the access openings.

FIG. 15 is a section detail illustrating operation of the dogs of FIGS. 13 and 14.

FIG. 16 is a section detail illustrating operation of the dogs of FIGS. 13 and 14.

FIG. 17 is a detail view of the end of the section illustrating the dogs closing an access opening.

FIG. 18 is a top view of the section of FIG. 17.

FIG. 19 is a section view of the section of FIG. 17 taken along section lines 19-19 as shown in FIG. 17.

### DETAILED DESCRIPTION OF A PREFERRED EMBODIMENT

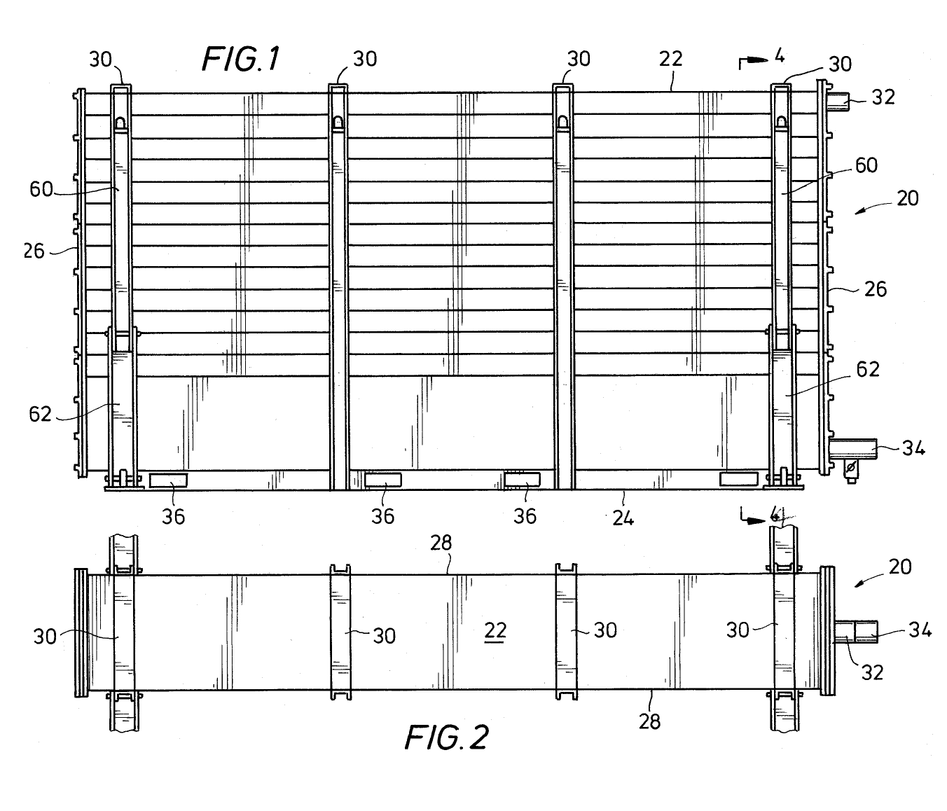

FIGS. 1 and 2 depict a presently preferred embodiment of a section 20 of a water clarification system constructed in accordance with the teachings of the present invention. The section 20 comprises a base vessel comprising primarily a top 22, a bottom 24, a pair of opposing ends 26, and a pair of opposing sides 28. The top, bottom, ends, and sides may be constructed of an appropriate strong material, such as metal, wood, composite material, or other material. However, in that embodiment, all interior surfaces that come into contact with water under treatment flowing through the system are covered with a non-reactive plastic. To enhance the rigidity of the section 20, a plurality of supporting ribs 30 encircle the section.

However, the construction material of the base vessel is preferably polyethylene, polypropylene or co-poly (a composite of polyethylene and polypropylene) with the potential polymeric reinforcement with glass fibers or talc rather than the base vessel being lined with a non-reactive plastic. The poly material is electro-fused to form a structural, waterproof seal between the channels and can be further reinforced with inlaid metal or composite ribs between the poly layers of the channel walls.

Waste water for treatment is introduced into the section at an inlet 32 and discharged from the section at a drain 34. The water under treatment flows in a cascade fashion through the section as described below. A plurality of openings 36 are also provided to aid in moving the section around a worksite either with a forklift of manually, as well as on and off a transport vehicle.

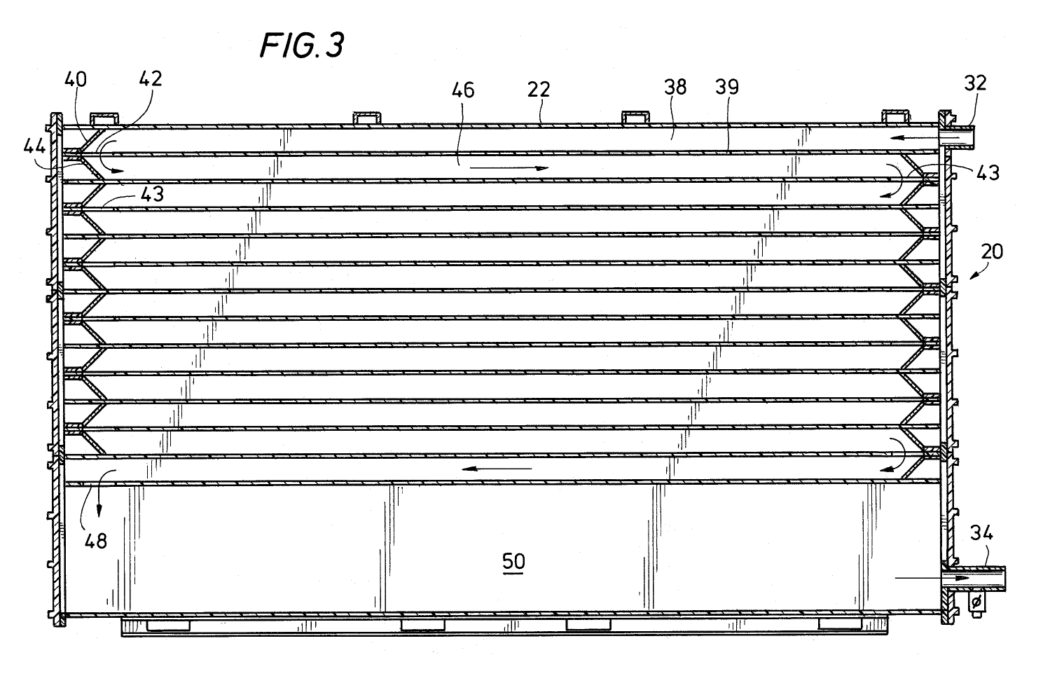

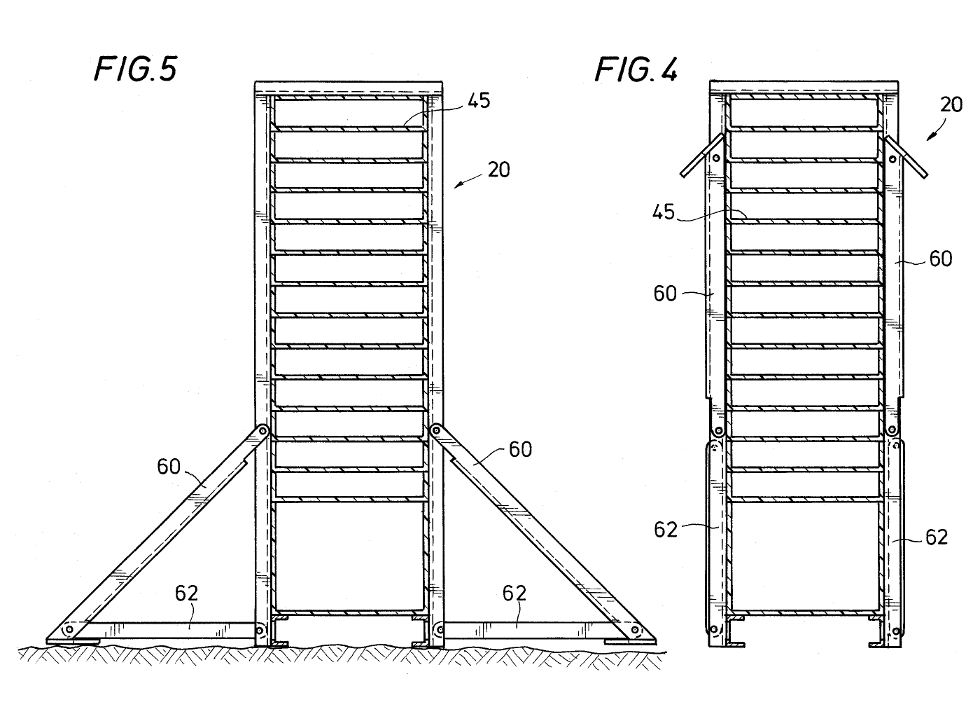

FIG. 3 shows the cascade flow path of water under treatment through the section 20. Waste water enters the section at the inlet 32 and flows into a channel 38. The system includes a plurality of such channels, formed by a plurality of horizontal plates 39. Typically, the waste water is pumped from a reservoir of other retention means. The waste water flow in a substantially horizontal direction until it encounters a first member 40 of a diverter valve. The water is directed through an opening 42 and is redirected by a second member 44 of the diverter valve. The opening 42 preferably includes a sliding throttle mechanism 43 to control the rate of flow through the opening 42. The opening 42 also preferably includes a movable tray including a flocculant for the water to flow through. In addition to the removable flocculent “trays” 45 (see FIGS. 4 and 5) so that the water under treatment flows over and under, adsorbent matting can be inserted into the channels to remove oils and/or free hydrocarbons.

The water then flows in the opposite direction through the section until it reaches another diverter valve. It continues to flow back and forth until it reaches a discharge opening 48. It flows into a retention tank 50 where material such as solid contaminants removed from the water settle to the bottom and the treated water flows out the drain 34. A removable fabric bag is inserted into the retention tank 50 from either end to accumulate the precipitated sediment.

Contaminant particles smaller than 0.1 μm (10−7 m) in water remain continuously in motion due to electrostatic charge (often negative) which causes them to repel each other. Once their electrostatic charge is neutralized by the use of coagulant chemical, the finer particles start to collide and agglomerate (combine together) under the influence of Van der Waal's forces. These larger and heavier particles are called flocs. Flocculents, or flocculating agents (also known as flocking agents), are chemicals that promote flocculation by causing colloids and other suspended particles in liquids to aggregate, forming a floc. Flocculents are used in water treatment processes to improve the sedimentation or filterability of small particles. For example, a flocculant may be used in a water treatment system to aid removal of microscopic particles which would otherwise cause the water to be turbid (cloudy) and which would be difficult or impossible to remove by filtration alone.

FIGS. 4 and 5 illustrate another feature of the invention. Those of skill in the art will appreciate that the section 20 can be a bit top heavy, particularly early in the treatment process with the top of the section is full of water under treatment and the bottom is full of air. Consequently, a pair of outrigger arms 60 and horizontal stabilizer arms 62 are provided to provide stability. The outrigger arms 60 and the stabilizer arms 62 collapse into the section as shown in FIG. 4, and are selectively deployed for operation as shown in FIG. 5.

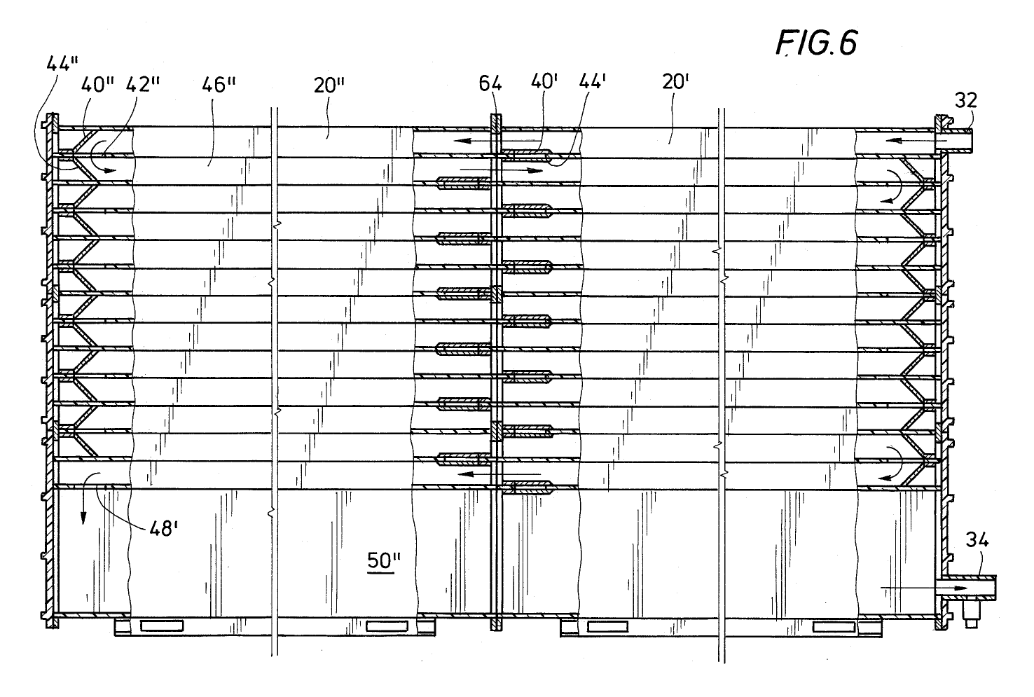

The section 20 includes all of the necessary structure to effectively treat water as a particular flow rate and level of contamination. However, some work sites may provide waste water that requires more treatment. In this even, two or more sections may be coupled together as shown in FIGS. 6 through 10, inclusive.

A first section 20′ is coupled to a second section 20″ at an interface 64. The diverter valve including a first element 40 and a second element 44′ is open, so that water flows straight through. Water under treatment continues to flow through the channel in the section 20″ until it encounters a first element 40″ of a diverter valve, downward through an opening 42″ and is directed by a element 44″ of the diverter valve back in the opposite direction through a channel 46″. The water under treatment continues to flow in a cascade fashion, encountering throttle valves and flocculant trays along the way as previously described, until it reaches a discharge opening 48″. The water then flows into a tank 50″ where the contaminants settle out and the treated water is removed through the drain 34.

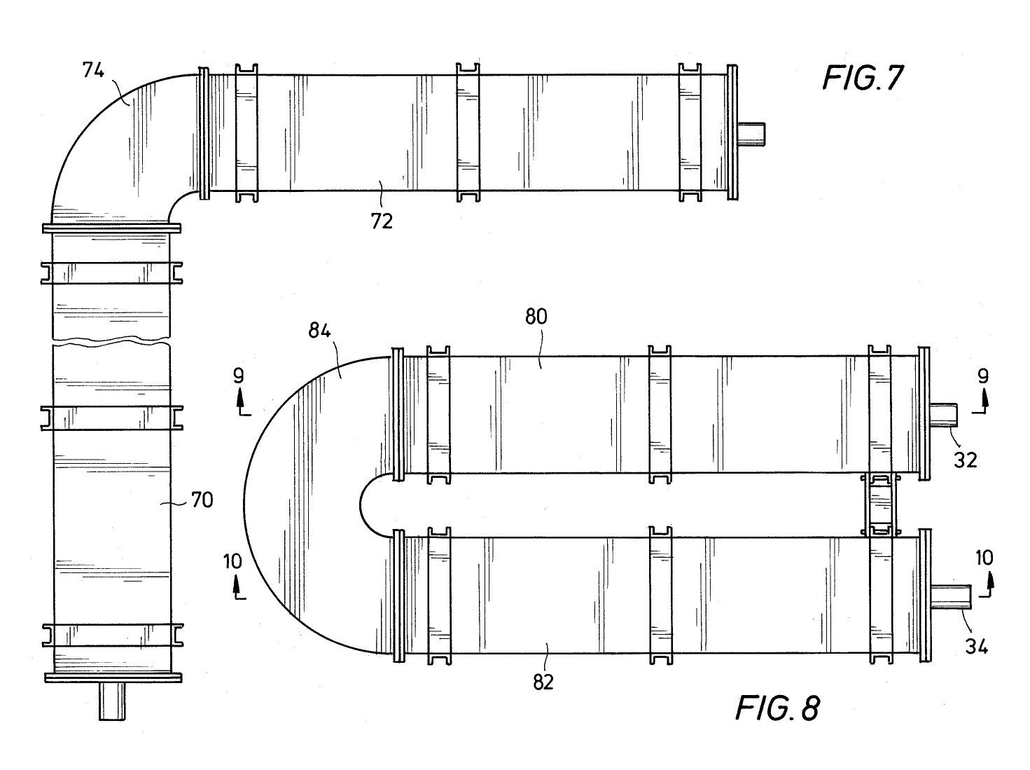

Other work sites may be only corner areas available for the installation of the water treatment system or they may have only a short, but relatively wide area for the installation. FIGS. 7 through 10 inclusive show how this invention solves this problem. If FIG. 7, a first section 70 is coupled to a second section 72 with a right angle (90°) section 74. Preferably, the right angle section 74 is simply a set of channels to redirect the flow from one section to another.

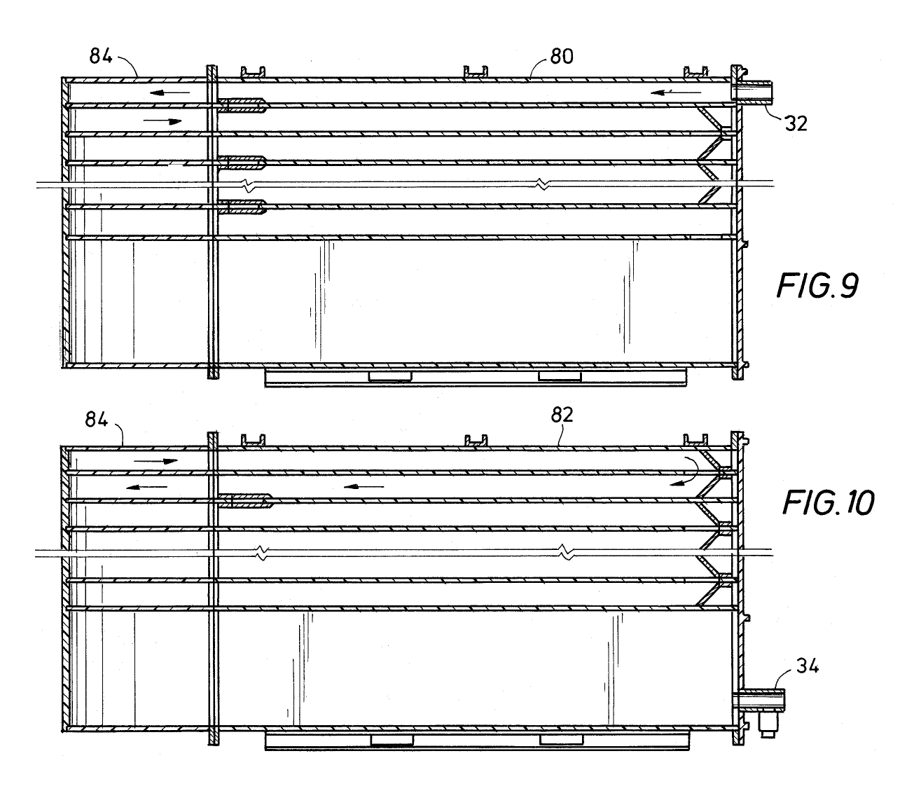

Similarly, in FIGS. 8 through 10 inclusive, a 180° section 84 couples a first section 80 to a second section 82. Diverter valves are opened or shut as necessary to direct the flow of water under treatment as shown in FIGS. 9 and 10.

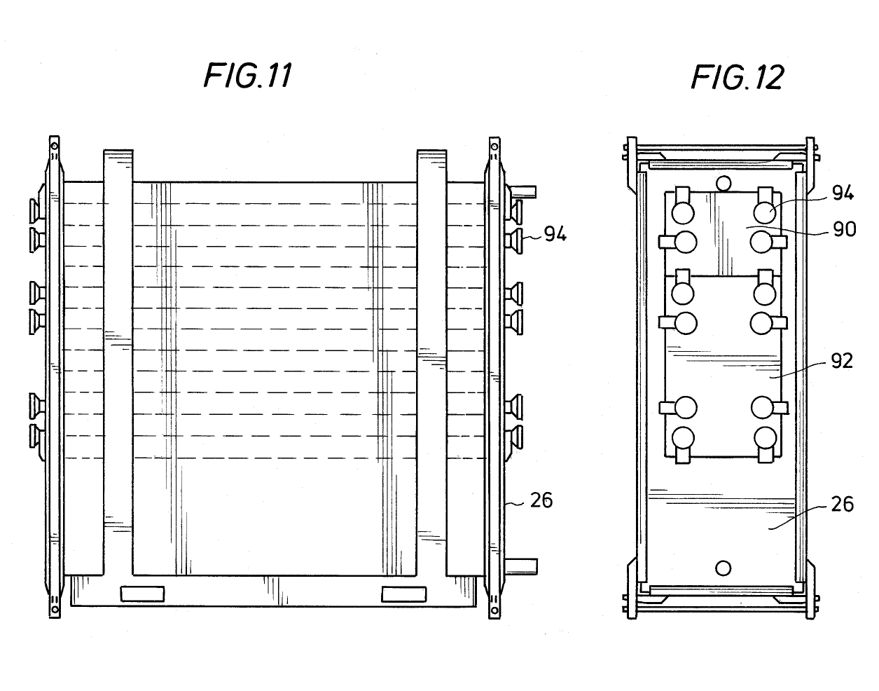

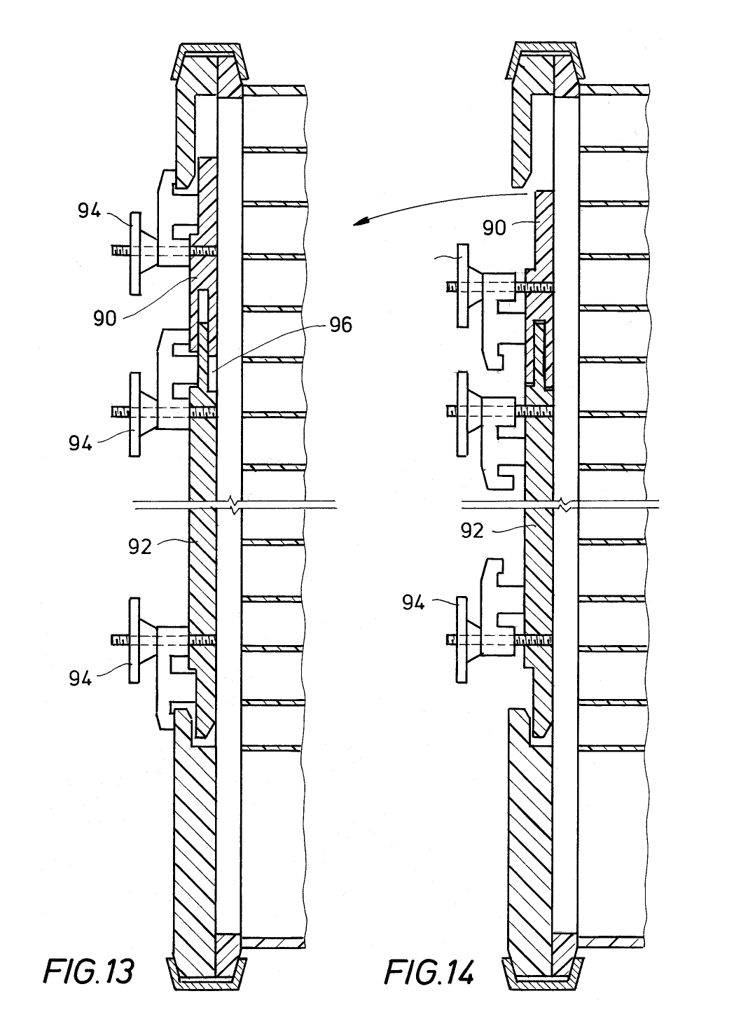

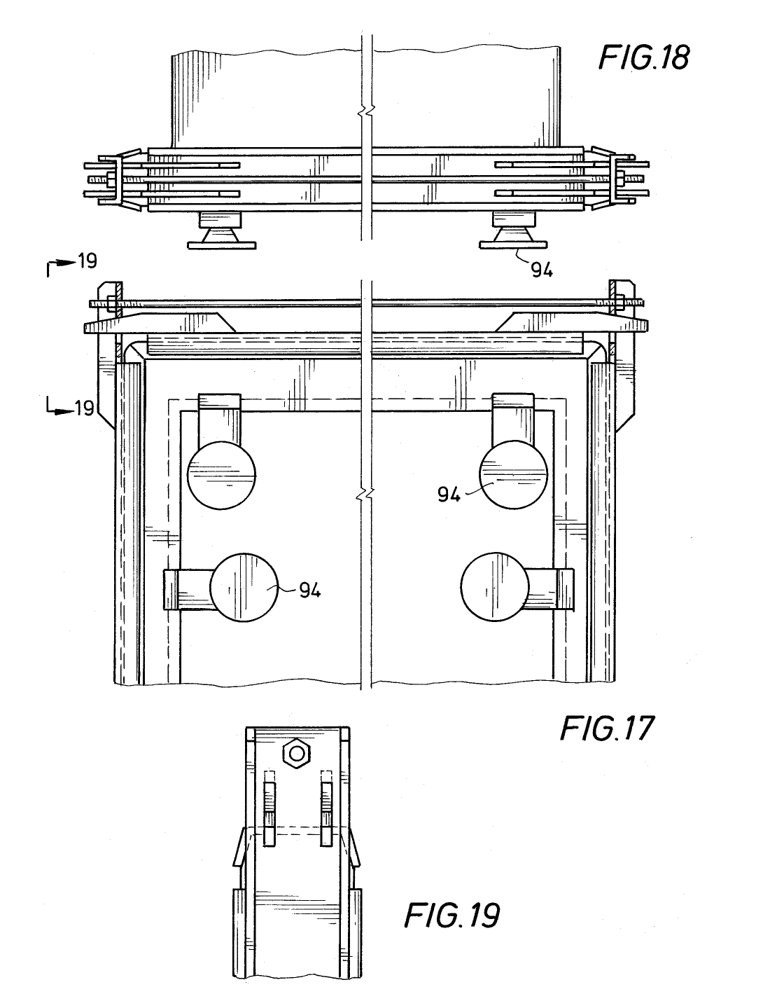

Access into the interior of the sections is necessary for a number of reasons. For example, an operator needs to open up the system to replace flocculant trays, to open or shut diverter valves, or flush out the settling tanks. Access to the interior is provided by doors as shown in FIG. 11 through 19, inclusive.

It will be understood by those of skill in the art that the structure and method just described can be used for air treatment in addition to fluid treatment. Furthermore, the direction of flow can be upward from the bottom reservoir or downward from the top.

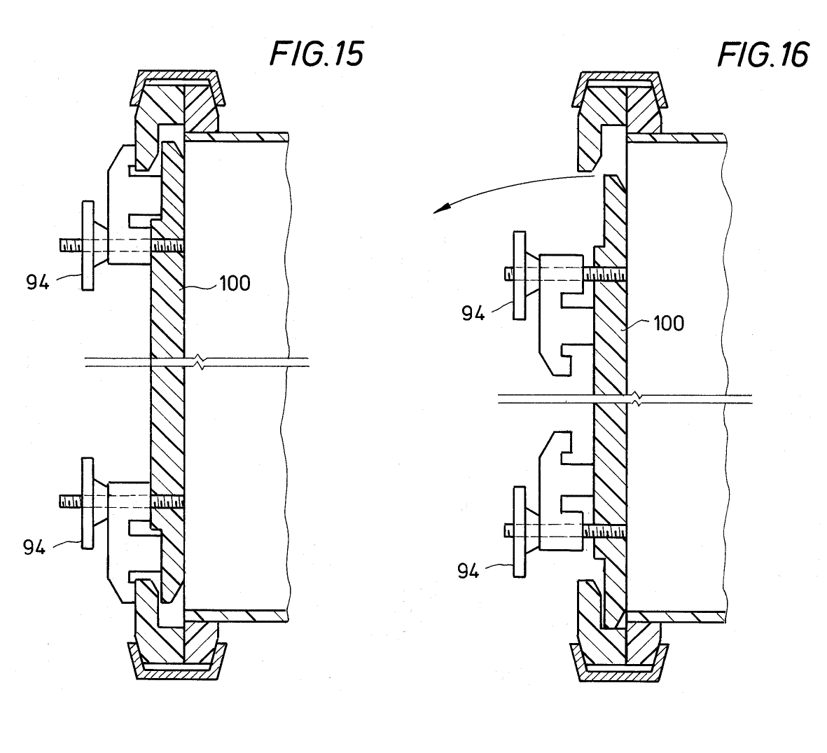

As shown in FIG. 12, a pair of nested doors 90 and 92 are held in sealing engagement with the end 26 of the section by a plurality of dogs 94. To open the doors, the dogs are loosened and rotated out of the way, then the door 90 is slid in further engagement with the door 92, and the doors are free to be removed. For a unitary door a similar arrangement is provided as shown in FIGS. 15 through 19.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

I claim:

1. A water clarification system to clarify water under treatment flowing through the system, the system comprising:
a base vessel comprising a top, a bottom, a pair of opposing ends, and a pair of opposing sides;
an inlet for directing water under treatment into the system and an outlet for directing treated water from the system; and
a plurality of interior surfaces, wherein all interior surfaces that come into contact with water under treatment flowing through the system are covered with a non-reactive plastic.

2. The system of claim 1, further comprising a plurality of horizontal flow channels formed by a plurality of horizontal plates, wherein each of the plurality of horizontal flow channels defines a first end and a second end.

3. The system of claim 2, further comprising a first diverter valve at the first end of a first flow channel and a second diverter valve at the second end of the first flow channel to direct water under treatment from treatment through an opening in the respective horizontal plate.

4. The system of claim 3, further comprising a sliding throttle mechanism across the opening.

5. The system of claim 3, further comprising a removable flocculent tray across the opening.

6. The system of claim 1, wherein the system comprises a first modular section, a second modular section, and a coupling to join the first and second modular sections together.

7. The system of claim 6, wherein the coupling comprises a 90° coupling to join the first and second modular sections together.

8. The system of claim 6, wherein the coupling comprises a 180° coupling to join the first and second modular sections together.

9. The system of claim 1, further comprising a retention tank at the bottom of the base vessel arranged to receive material removed from the water under treatment, and wherein the outlet extends from the retention tank.

10. The system of claim 1, further comprising;
a pair of selectively deployable and collapsible outrigger arms hingedly mounted to the opposing sides; and
a pair of selectively deployable and collapsible horizontal stabilizer arms hingedly mounted to the outrigger arms and the opposing sides.
